(19) United States
(12) Patent Application Publication
(10) Pub. No.: US 2017/0011303 A1
(43) Pub. Date: Jan. 12, 2017

(54) Contact-Based Predictive Response

(71) Applicant: QUALCOMM Incorporated, San Diego, CA (US)

(72) Inventors: Koushik Annapureddy, Tampere (FI); Keir Finlow-Bates, Kangasala (FI)

(21) Appl. No.: 14/794,937

(22) Filed: Jul. 9, 2015

(51) Int. Cl. G06N 7/00; G06F 17/30; H04L 29/08

(52) U.S. Cl. CPC G06N 7/005; H04L 67/22; G06F 17/30312

(57) ABSTRACT

Various embodiments include methods implemented on a mobile communication device for using a contact-based predictive response database on a communication device. The methods include determining communication context information from a communication exchange between a user using the communication device and a contact, selecting a predictive response database associated with the contact, determining a suggested communication element from the predictive response database based on a prior communication element identified from the communication exchange and the communication context information, and providing the suggested communication element to the user.

### BACKGROUND

Many communication devices utilize predictive text programs to predict and suggest text for users while they are typing, such as in a document, email message, short message service (SMS) or text message. A predictive text feature predicts and suggests text that a user may want to enter next, for example, based on historical information about words the user frequently uses. Such features are useful because they reduce the amount of time a user may spend generating a message.

### SUMMARY

Various embodiments include methods implemented on a mobile communication device for using a contact-based predictive response database on a communication device. Various embodiment methods may include determining communication context information from a communication exchange between a user using the communication device and a contact, selecting a predictive response database associated with the contact, determining a suggested communication element from the predictive response database based on a prior communication element identified from the communication exchange and the communication context information, and providing the suggested communication element to the user, such as a suggested text (letters or words), emoticon, or action (e.g., attaching a particular picture, graphic, or other communication object).

In some embodiments, the communication context information may include a communication input already entered by the user. In some embodiments, the communication context information may include at least one of a time of the communication exchange, a location of the user during the communication exchange, a language of the communication exchange, and a medium of the communication exchange. In some embodiments, the prior communication element may include a word, a phrase, an emoticon, a noted action, or a null value. In some embodiments, the communication exchange may include a text translation of a voice call communication.

In some embodiments, selecting a predictive response database associated with the contact may include selecting the predictive response database associated with an identifier of the contact. In some embodiments, determining a suggested communication element may include ranking elements in the predictive response database by comparing the prior communication element and the communication context information with context metadata of each element stored in the predictive response database. In some embodiments, the suggested communication element may include a word, a phrase, an action, or an emoticon.

In some embodiments, the method may further include updating the predictive response database with the suggested communication element by correlating the suggested communication element with the prior communication element, and updating context metadata for the suggested communication element stored in the predictive response database with the communication context information and the correlation between the suggested communication element and the prior communication element.

Some embodiments may further include determining whether the selected predictive response database is similar to another predictive response database, and grouping the selected predictive response database and the another predictive response database in response to determining that the selected predictive response database is similar to another predictive response database. In some embodiments, selecting a predictive response database associated with the contact may include correlating user elements and contact elements in the communication exchange, and determining whether the correlation between the user elements and the contact elements and the communication context information are similar to context metadata of elements stored in the predictive response database.

Some embodiments may further include generating a new contact-based predictive response database associated with the contact that may include storing the communication exchange, in which the communication exchange may include communication from the user, identifying a user element in the communication from the user, generating context metadata for the user element, in which the context metadata may include a correlation between the user element and the identified prior communication element, and storing the context metadata in the new contact-based predictive response database associated with the contact. In such embodiments, the communication exchange may include an instant message communication, a text message communication, an email communication, a text translation of a voice call communication, and a social media communication. In such embodiments, a user element may include a word, a phrase, a noted action, or an emoticon, and the contact communication element may include a word, a phrase, an emoticon, or an action (e.g., attaching a graphic, image or audio file). In some embodiments, the prior communication element may include a prior contact communication element.

Further embodiments include a communication device including a processor configured with processor-executable instructions to perform operations of the embodiment methods described above. Further embodiments include a non-transitory processor-readable storage medium having stored thereon processor-executable software instructions configured to cause a processor to perform operations of the embodiment methods described above. Further embodiments include a communication device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the disclosed systems and methods.

FIG. 1 is a communication system block diagram of mobile telephony networks suitable for use with various embodiments.

FIG. 2 is a component block diagram of a communication device according to various embodiments.

FIGS. 3A-3C are block diagrams illustrating a contact-based predictive text feature in a communication device according to various embodiments.

FIG. 4 is an example of a contact-based predictive response database according to various embodiments.

FIG. 5 is a process flow diagram illustrating a method for implementing a contact-based predictive response feature according to various embodiments.

FIG. 6 is a process flow diagram illustrating a method for using a contact-based predictive response feature according to various embodiments.

FIG. 7 is a process flow diagram illustrating a method comparing and relating contact-based predictive response databases according to various embodiments.

FIG. 8 is a component block diagram of a communication device suitable for implementing some embodiment methods.

FIG. 9 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device” or “communication device” refers to any one or all of cellular telephones, smart phones, smart watches, personal or mobile multi-media players, personal data assistants, laptop computers, tablet computers, smart books, palm-top computers, wireless electronic mail receivers, multimedia Internet-enabled cellular telephones, wireless gaming controllers, and similar personal electronic devices that includes a programmable processor, memory, and circuitry for connecting to one or more other communication devices, networks, base stations, and other intermediary communication nodes. Various embodiments may be useful in mobile communication devices, such as smart phones, and so such devices are referred to in the descriptions of various embodiments.

Many communication devices utilize predictive text programs to predict and suggest text for users while they are typing, such as in a document, email message, or short message service (SMS) or text message. Such programs usually predict text from a global database or record the frequency with which users have entered certain words in the past. When a user starts typing the beginning portion of text, termed a prefix, the predictive text program may suggest the most frequently used words that match the prefix. For example, if a user started to type the prefix “gov” in a text message, the predictive text program may suggest the word “government” to the user. If the user selects the suggestion, the predictive text program fills in the rest of the word automatically. However, current predictive text programs are contact agnostic, meaning they do not take into consideration the identity of the contacts that the user communicates with. Further, current predictive text programs do not take into consideration the specific context of the user communication when making predictions and suggestions. For example, the set of words that a user uses when communicating with family members may be very different from the set of words that the user uses when communicating with coworkers. For example, a user may discuss work-related topics with a colleague but domestic-related topics with a spouse. However, current predictive text program may suggest work-related words when the user is communicating with the spouse, and may suggest domestic-related words when the user is communicating with the colleague. In addition, current predictive text programs only take into consideration the text entered by the user, and not communications received from a contact, when generating a suggestion. This results in inefficient predictions by the predictive text program.

In addition, current predictive text programs only suggest text and are not capable of predicting other kinds of responses that users might use when responding to received communications, such as emoticons, attaching a graphic or photograph, attaching an audio file), etc. Thus, conventional predictive text programs do not support the full range of communication responses that users may use routinely when communicating with contacts such as friends, family and colleagues. In overview, the various embodiments provide methods implemented with a processor of a communication device that provide a contact-based predictive response program or feature. The communication device may store in memory one or more predictive response databases, each predictive response database associated with one or more specific contacts of the user of the communication device. When the user communicates with a contact, the predictive response program draws communication elements such as words, emoticons, objects or files from the predictive response database associated with that particular contact, and thus may suggest responses including text, emoticons or other communication activity associated with the contact and consistent with a communication context. This allows the predictive response program to consider the context of the communication and utilize specialized predictive response databases according to the context of the communication (e.g., the contact receiving the communication as well as other contextual characteristics of the communication) rather using a global predictive response database.

A predictive response program in a communication device may receive and store a communication exchange between a sender sending communication from the communication device (hereinafter the “user”) and a recipient of the communication (hereinafter the “contact”). The predictive response program may identify one or more communication elements, including user and/or contact elements, from the communication exchange. An element may be a word, phrase, emoticon, and/or a noted action (e.g., noting that a contact attached a file) in the communication exchange. Context metadata may be generated for the user elements, where the context metadata includes a correlation between the user element and one or more prior communication elements, including contact elements or prior user elements. For example, a user element may be the word “school.” The elements correlated with the user elements may be the last three words the contact sent to the user before the user enters the word “school.” For example, the contact may have sent the user a message saying “Are the kids still at home?” and the user may respond with a message saying “No, they are still at school.” The predictive response program may correlate the words “school” typed by the user with the words “kids,” “still,” and “home” typed by the contact, and store the correlation as context metadata for the user element “school.” Additionally, the predictive response program may also correlate prior elements inputted by the user to the current user element “school.” For example, the predictive response program may correlate the word “still” inputted by the user prior to the word “school.” Additional context information or metadata may be extracted from the communication exchange, such as the date and time of the communication exchange, the location of the user and/or contact during the communication exchange, the language of the communication exchange, and the medium of the communication exchange (e.g., text message, email, instant message, social media interaction, chat room, voice call that has been translated to text).

The predictive response program may store the extracted context information in a predictive response database or other data structure, such as contact-associated records, tables, or arrays (hereinafter generally referred to as a “predictive response database”). In an example, the predictive response program may have access to multiple records within a database and/or multiple databases. In another example, one or more predictive response databases may be indexed by a contact identifier, such as a phone number, email address, user name, or other identifier used by the contact to communicate with the user. In some cases the contact may have multiple identifiers for multiple communication accounts. In such cases, one of the identifiers may be designated as a master identifier for the predictive response database, or a new master identifier may be generated for the contact (e.g., the name of the contact). A list or table may be stored that links all the various identifiers associated with the same contact. The predictive response program may determine whether an entry for the user element already exists in the predictive response database. If an entry does exist, the predictive response program may update the entry with the context metadata extracted from the communication exchange. If an entry does not exist, the predictive response program may add the user element and its associated context metadata to the predictive response database. The predictive response program may continue to analyze the communication exchanges of the user and various contacts, and add or update entries in the predictive response database associated with particular contacts. In this manner, the predictive response program may construct one or more contact-based predictive response databases.

When the user is in communication with a contact, the predictive response program may provide suggestions to the user in response to a request and/or an indication of the user initiating and/or engaging in communication with a contact. The predictive response program may retrieve a contact identifier for the contact, for example, based on an email address, phone number, username, or some other contact information that the user is using to communicate with the contact. The predictive response program may determine communication context information for the communication exchange between the user and the contact. The communication context information may include the last few words exchanged between the contact and the user, a portion of text (or other communication elements) that the user has already entered, and other information such as the time of the communication exchange, location of the user and/or contact during the communication exchange, language of the communication exchange, and the medium of the communication exchange.

The predictive response program may select a predictive response database based on the contact, for example based on the received contact identifier. If no predictive response database exists for the contact, the predictive response program may create a new predictive response database based on the ongoing communication and associate the new predictive response database with the contact.

Upon identifying the correct database, the predictive response program may determine one or more suggested communication elements based on the communication context information, and provide the suggested communication elements to the user. For example, if the contact sent a message saying “Have the kids left home?” and the user has entered the letter “s,” the communication context information may include the identity of the contact (e.g., spouse), the prefix “s,” and the last few words sent by the contact: “kids,” “left,” and “home.” The predictive response program may determine from the predictive response database associated with the contact that the word “school” is correlated with the words “kids” and “home,” and that the user has entered the letter “s.” The predictive response program may then provide a suggested communication element of “school” to the user.

The predictive response program may evaluate the user input continuously while the user is continuing to input characters or take other actions. As the user enters an additional input, including for example, additional characters or other actions, the predictive response program may refine the suggested communication elements based on the additional input. Once the user accepts a suggested communication element or completes the input, the predictive response program may update the predictive response database associated with the contact with the entered input and the communication context information. In this manner, the predictive response program implements contact-based predictive responses based on observations of communication elements (e.g., words, letters, emoticons, graphics, image files, audio files, etc.) that the user includes in communications with the contact in response to various prompts and circumstances.

The predictive response program may additionally group or merge predictive response databases. For example, the same contact may use different identifiers to communicate with the user (e.g., phone number, email, social media usernames). The predictive response program may initially create different predictive response databases for each contact identifier. In some embodiments, the predictive response program may determine whether two or more predictive response databases are associated with the same contact (e.g., by asking the user to confirm). In some embodiments, if the predictive response databases belong to the same contact, the predictive response program may merge the predictive response databases together into a single database for that contact. In some embodiments, if the predictive response databases belong to the same contact, the predictive response program may group or link the predictive response databases together with a master contact identifier. If the predictive response databases do not belong to the same contact, the predictive response program may still determine whether two or more predictive response databases are similar. If the predictive response databases are similar but do not belong to the same contact, the predictive response program may group or link the predictive response databases together. This allows the predictive response database to leverage similar predictive response databases to propose suggestions when the communication patterns of the user with various contacts are similar. For example, a communication device may store predictive response databases for two contacts who are both coworkers of the user. The user may have similar conversation patterns with both contacts. The predictive response program may determine that the predictive response databases for both contacts are similar and group the databases together. When the user communicates with either contact, the predictive response program may use information stored in either database, or combine information from both databases, to provide suggestions to the user.

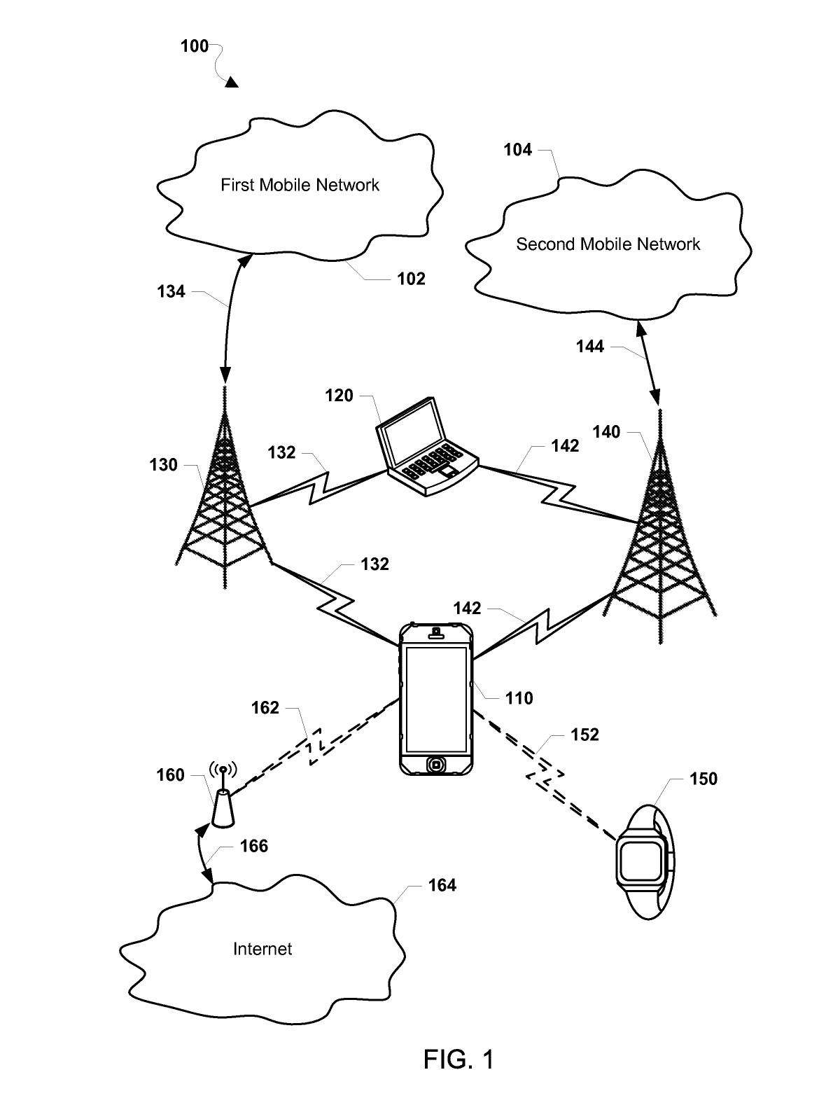

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first communication device 110 may be in communication with the first mobile network 102 through a cellular connection 132 to the first base station 130. The first mobile communication device 110 may also be in communication with the second mobile network 104 through a cellular connection 142 to the second base station 140. The first communication device 110 may also be able to communicate with the first mobile network 102 and/or the second mobile network 104 through a non-cellular connection, such as a WiFi connection. The first base station 130 may be in communication with the first mobile network 102 over a wired connection 134. The second base station 140 may be in communication with the second mobile network 104 over a wired connection 144.

A second communication device 120 may similarly communicate with the first mobile network 102 through the cellular connection 132 to the first base station 130. The second communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), and Universal Mobile Telecommunications Systems (UMTS), and other mobile telephony communication technologies. The second communication device 120 may also be able to communicate with the first mobile network 102 and/or the second mobile network 104 through a non-cellular connection, such as a WiFi connection, an Ethernet connection, optical fiber connection, cable or telephone line connection, satellite connection, or other wired or wireless local area network (LAN) or wide area network (WAN) connections.

While the communication devices 110, 120 are shown connected to the first mobile network 102 and, optionally, to the second mobile network 104, in some embodiments (not shown), the communication devices 110, 120 may include two or more subscriptions to two or more mobile networks and may connect to those subscriptions in a manner similar to those described above.

In some embodiments, the first communication device 110 may optionally establish a wireless connection 152 with a peripheral device 150 used in connection with the first communication device 110. For example, the mobile communication device 110 may communicate over a Bluetooth® link with a Bluetooth-enabled personal computing device (e.g., a “smart watch”). In some embodiments, the first communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second communication device 120 may similarly be configured to connect with the peripheral device 150 and/or the wireless access point 160 over wireless links.

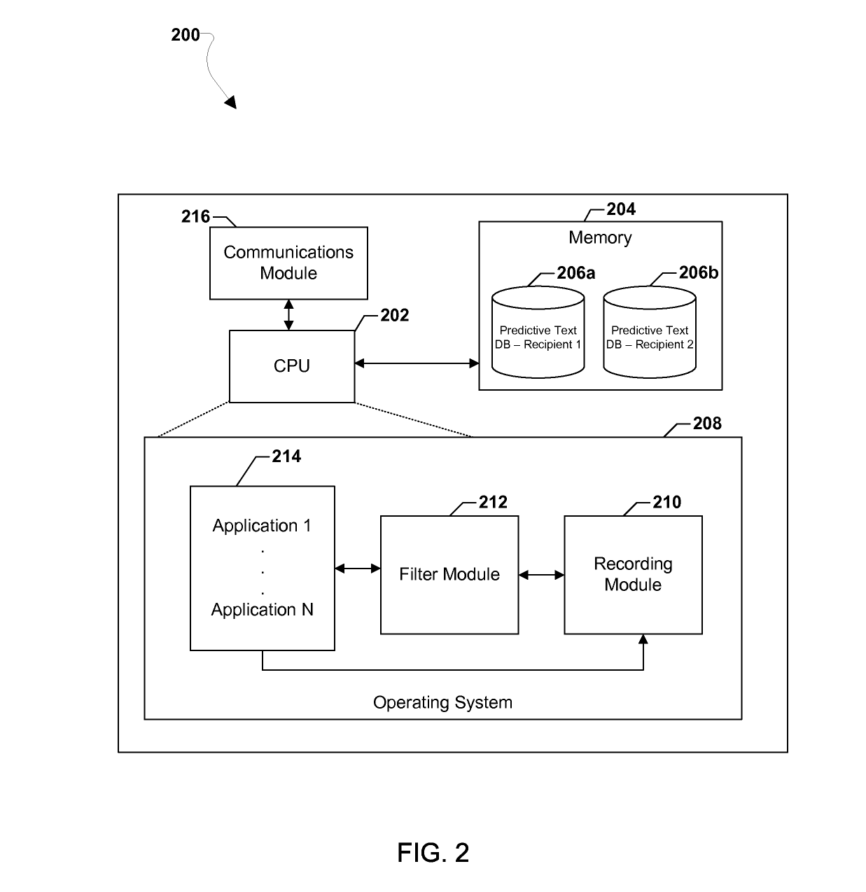

FIG. 2 is a functional block diagram of a communication device 200 suitable for implementing various embodiments. With reference to FIGS. 1-2, the communication device 200 may be similar to one or more of the communication devices 110 and 120 as described. The communication device 200 may include at least one controller, such as a general processor 202 coupled to the memory 204 and communications module 216. In one example, the memory 204 may be a non-transitory computer-readable storage medium that stores processor-executable instructions and data. The memory 204 may store one or more contact-based predictive response databases 206a, 206b. The memory 204 may also store a global predictive response database.

The memory 204 may also store processor-executable instructions for implementing an operating system 208, as well as programs, modules, and functions implemented within the operating system 208, such as recording module 210, filter module 212, and applications 214. The recording module 210, filter module 212, and the contact-based predictive response databases 206a, 206b may, together, implement a contact-based auto suggestion program. The recording module 210 may be coupled to the memory 204 in order to access the contact-based predictive response databases 206a, 206b. The recording module 210 and filter module 212 may be in communication with applications 214, which may include one or more applications for communication, such as web browsers, chat applications, text applications, email applications, social media applications, and voice call logger applications. The recording module and filter module 212 may provide contact-based predictive response services to the applications 214. The recording module 210 and filter module 212 may also be implemented in components other than the operating system 208, such as a standalone application within the operating system 208 or as part of lower level components.

The communications module 216 may include one or more baseband modem processors, one or more radio frequency (RF) resources, one or more antennas, one or more subscriber identity module (SIM) interfaces for SIM cards, and one or more interfaces for wired communication connections. The various components in the communications module 216 may form one or more baseband-RF resource chains for a radio access technology (RAT), such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), and Universal Mobile Telecommunications Systems (UMTS). The communications module 216 may also be able to connect to various communication networks through non-cellular connections, such as through WiFi, an Ethernet connection, or other wired or wireless connections, an Ethernet connection, optical fiber connection, cable or telephone line connection, satellite connection, or other wired or wireless local area network (LAN) or wide area network (WAN) connections.

A SIM in various embodiments may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read-only memory (ROM), random access memory (RAM), electrically erasable programmable read-only memory (EEPROM), and input/output (I/O) circuits.

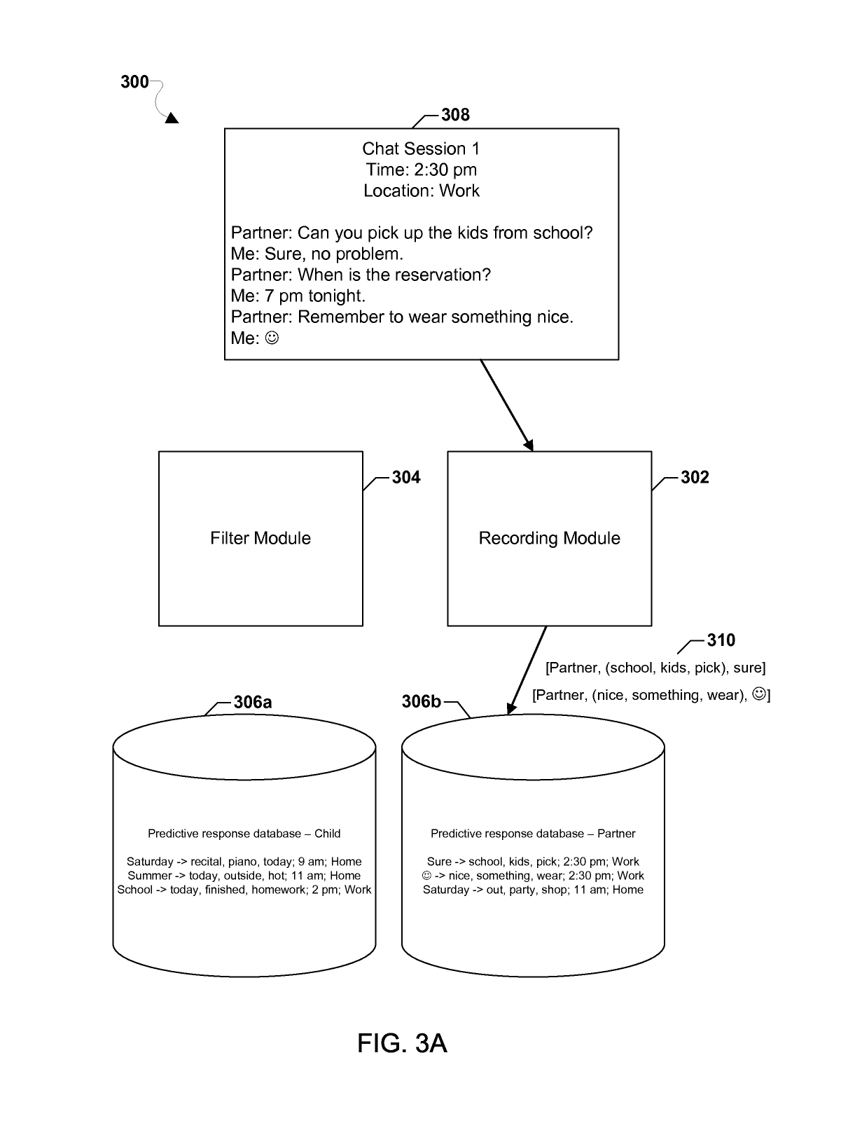

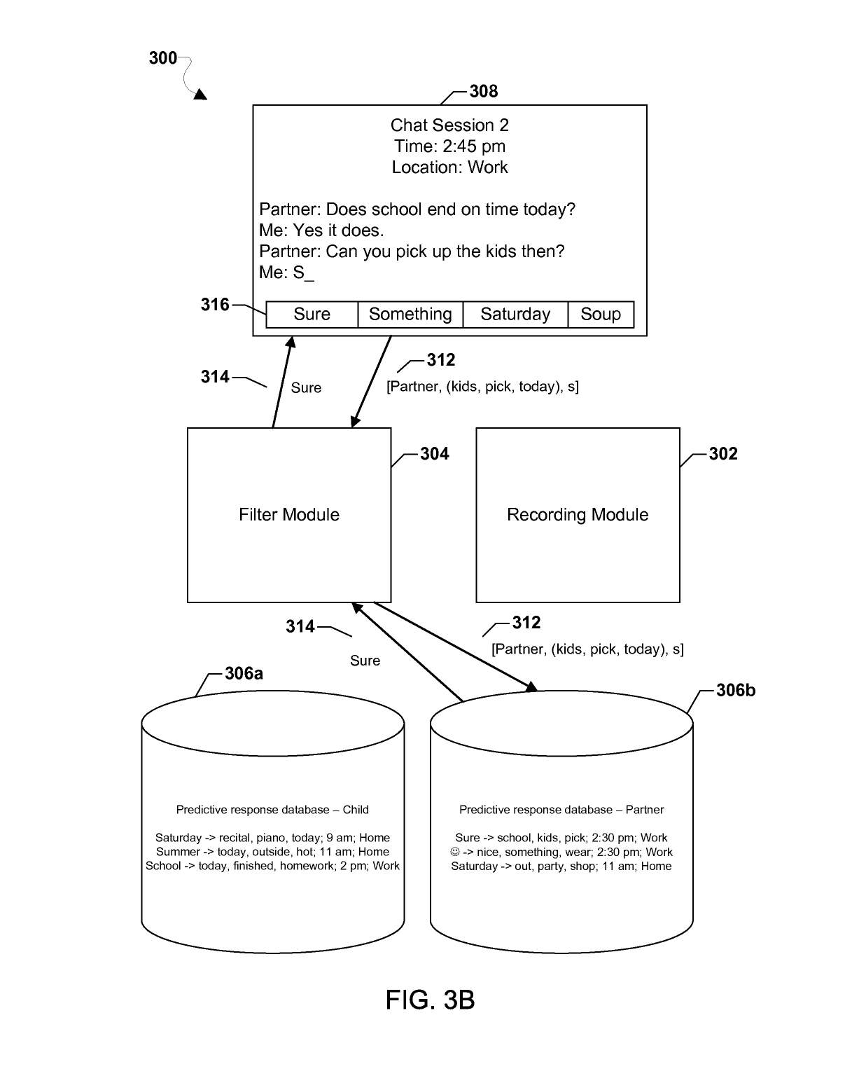

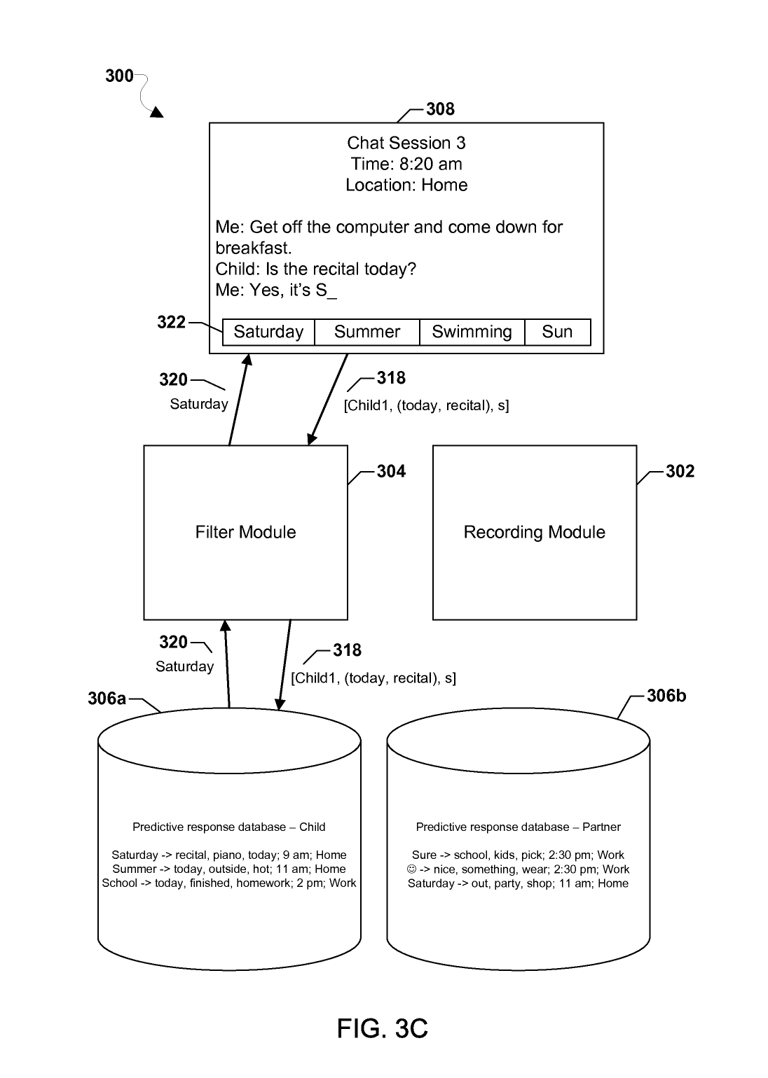

FIGS. 3A-3C illustrate block diagrams of components of a communication device 300 for implementing a contact-based predictive response program. With reference to FIGS. 1-3C, the communication device 300 may be similar to one or more of the communication devices 110, 120, and 200 as described. With reference to FIG. 3A, the communication device 300 belongs to a person (referred to as a “user” from the perspective of the communication device 300) in a communication exchange with a contact. The communication device 300 includes a recording module 302 for recording context metadata of the communication exchange, and in particular correlations between elements of user communication and elements of contact communication and/or prior user communication. The communication device 300 also includes a filter module 304 for providing contact-based suggested communication elements to the user. The communication device 300 also includes one or more predictive response databases 306a, 306b, each associated with a contact, through for example a contact identifier. For example, the predictive response database 306a may be associated with a “Child” contact while the predictive response database 306b may be associated with a “Partner” contact. The contact identifier may be an email address, phone number, username, or user nickname.

The communication device 300 may include an application 308 used by the user to engage in a communication exchange with a contact. The application 308 may be an email application, web browser application, chat application, text message application, social media application, a voice call logger application that translates voice calls to text data or other application facilitating communication between a user and a contact. As illustrated in FIG. 3A, the application 308 is a chat application facilitating a chat session between the user (“Me”) and a contact (“Partner”). As shown in FIG. 3A, the time of the chat session is 2:30 pm and the user's location is at work.

The recording module 302 is in communication with the application 308 and may collect information to populate the predictive response database 306b associated with the Partner contact from the communication exchange occurring in the application 308. The recording module 302 may identify one or more user elements in the communication exchange and correlate context metadata 310 for each user element. The context metadata 310 describes the context of the communication exchange surrounding the use of the user element by the user. A user element may be any component of the user's communication to the contact, such as words, phrases, actions, and emoticons. The context metadata may include one or more contact or user communication elements in the communication exchange that are correlated with the user element. An element may be any component of the either contact's communication to the user or the user's communication to the contact, such as words, phrases, emoticons, noted actions (e.g., noting that the contact attached a file), or a null value if the contact or user has not communicated anything yet. For example, the recording module 302 may correlate a user element with N number of preceding contact or user communication elements. With reference to FIG. 3A, the recording module 302 may correlate the user element “sure” which was sent to the contact with the contact elements “school,” “kids,” and pick,” which were sent by the contact to the user prior to the user's use of the element “sure.” Similarly, the recording module 302 may correlate the user element “ [symbol] ” (an emoticon) with the contact elements “nice,” “something,” and “wear” which were sent by the contact prior to the user's use of the element “ [symbol] .” The recording module 302 may also correlate prior user elements to the present user elements (e.g., inputs of the user prior to the current user element). For example, the recording module 302 may also correlate prior user elements with the element “ [symbol] ,” such as the element “tonight.”

The recording module 302 may correlate any number of contact or prior user communication elements to a user element as part of the context metadata 310. The recording module 302 may ignore certain common words when correlating elements to the user element, such as “the” and “a.” The recording module 302 may also add additional information as part of the context metadata 310, such as the date or time of the communication exchange, the location of the communication exchange, the language of the communication exchange, and the medium of the communication exchange (e.g., chat, text message, email, social media interaction, voice call).

The recording module 302 may then store the context metadata 310 in the predictive response database 306b associated with the Partner contact. For example, the context metadata 310 may be formatted as a tuple containing a contact identifier, the user element, and the context metadata. As illustrated in FIG. 3A, one tuple may include the contact identifier “Partner,” the user element “sure,” and the correlated elements “school,” “kids,” and “pick.” Another tuple may include the contact identifier “Partner,” the user element “©,” and the correlated elements “nice,” “something,” and “wear.” Additional context metadata, such as the time and location of the communication exchange, may also be included.

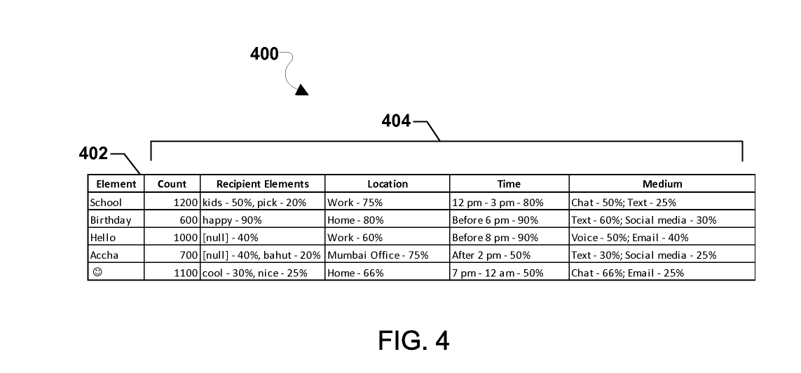

The recording module 302 may incorporate the context metadata into the predictive response database 306b by determining whether an entry for the user element already exists in the predictive response database 306b. If an entry does exist, the recording module 302 may update the stored context metadata with the new context metadata 310 (or any portion of the context metadata 310 that is not already stored in the database 306b). This may include incrementing a usage count of the user element, adding the correlated elements to previously correlated elements, incrementing a usage count or other statistics regarding the frequency of appearance of the correlated element; and updating statistics regarding time, location, language, or medium in which the user element has been used. If an entry for the user element does not exist, the recording module 302 may add the user element and associated context metadata to the predictive response database 306b. The structure of the predictive response database 306b is described in further detail with reference to FIG. 4.

At a later point in time, the user may engage in another communication exchange with the same contact, shown in FIG. 3B. In this example the user is using the application 308 to engage in another chat session with the Partner contact. During the communication exchange, the application 308 may send a request 312 to the filter module 304 to provide a suggested communication element to the user while the user is typing. For example, the user may have typed in the letter “s” as the beginning of a word. The request 312 may include a contact identifier (“Partner”) and communication context information. The communication context information may include a prefix already typed by the user (“s”). The communication context information may also include one or more contact or user communication elements entered or received by the user (e.g., the words “kids,” “pick,” and “today”). The communication context information may also include other information about the communication exchange, such as the date or time of the communication exchange, the location of the communication exchange, the language of the communication exchange, and the medium of the communication exchange. In some cases, the request 312 may not contain a prefix (e.g., if the user has not typed anything), or may not contain any contact communication elements (e.g., if the communication exchange has just begun). However, a suggested communication element may still be determined by the filter module 304.

The filter module 304 receives the request 312 and identifies a predictive response database based on the contact, in this case the predictive response database 306b. The filter module 304 may then access the predictive response database 306b and determine one or more suggested communication elements from the communication context information in the request 312. The filter module 304 may compare the communication context information with the context metadata of one or more user elements in the predictive response database 306b and rank each user element by how well the context metadata of the user element matches the communication context information. For example, the request 312 indicates a prefix “s” and so the filter module may search for user elements that begin with the letter “s.” In addition, the request 312 indicates the communication elements “kids,” “pick,” and “today.” The predictive response database 306b stores a user element “sure” that is correlated with the elements “school,” “kids,” and “pick.” The request 312 may also include the time of the communication exchange (2:45 pm) and the location of the user (work). The predictive response database 306b indicates the user element “sure” is correlated with the time 2:30 pm and with the work location. The filter module 304 may determine that the user element “sure” has a high ranking with respect to the communication context information included in the request 312. The filter module 304 may then send one or more suggested communication elements 314 to the application 308, such as the word “sure.” The filter module 304 may provide other suggested communication elements with high rankings with respect to the communication context information.

The communication device 300 may provide a suggestion panel 316 displaying one or more suggested communication elements 314 sent from the filter module 304 to the user. The user may select one of the suggested communication elements 314, or continue typing. If the user types additional letters in the prefix, the application 308 may request more suggestions and the filter module 304 may provide additional suggested communication elements based on any new communication context information, such as a new prefix. If the user accepts a suggested communication element or manually completes a user element, the recording module 302 may update the predictive response database 306b with the selected or completed word and the communication context information as described with reference to FIG. 3A.

At another point in time, the user may engage in a communication exchange with another contact, shown in FIG. 3C. In this example the user is using the application 308 to engage in a chat session with the Child contact. During the communication exchange, the application 308 may send a request 318 to the filter module 304 to provide one or more suggested communication elements to the user while the user is typing. For example, the user may have typed in the letter “s” as the beginning of a word. The request 318 may include a contact identifier (“Child”) and communication context information. The communication context information may include a prefix already typed by the user (“s”). The communication context information may also include one or more user or contact communication elements entered or received by the user (e.g., the words “today” and “recital”). The communication context information may also include other information about the communication exchange, such as the date or time of the communication exchange, the location of the communication exchange, the language of the communication exchange, and the medium of the communication exchange. For example, the request 318 may include the time of the communication exchange (8:20 am) and the location (home).

The filter module 304 receives the request 318 and selects a predictive response database based on the contact, in this case the predictive response database 306a. The filter module 304 may then access the predictive response database 306a and determine one or more suggested communication elements from the communication context information in the request 318. For example, the request 318 indicates a prefix “s” and so the filter module may search for user elements that begin with the letter “s.” In addition, the request 318 indicates the communication elements “recital” and “today.” The predictive response database 306a stores a user element “Saturday” that is correlated with the elements “recital,” “piano,” and “today.” The predictive response database 306a also indicates the user element “Saturday” is correlated with the time 9 am and with the home location. The filter module 304 may determine that the user element “Saturday” has a high ranking with respect to the communication context information included in the request 318. The filter module 304 may then make one or more suggested communication elements 320 to the application 308, including the user element “Saturday.” The filter module 304 may provide other suggested communication elements with high rankings with respect to the communication context information, such as the user element “Summer” which also matches well with the communication context information.

The communication device 300 may provide a suggestion panel 322 displaying one or more suggested communication elements 320 from the filter module 304 to the user. The user may select one of the suggested communication elements 320, or continue typing. If the user types additional letters in the prefix, the application 308 may request more suggestions and the filter module 304 may provide additional suggested communication elements based on the new communication context information, such as a new prefix. If the user accepts a suggested communication element or manually completes a user element, the recording module 302 may update the predictive response database 306a with the selected or completed word and the communication context information as described with reference to FIG. 3A.

FIG. 4 illustrates an example of a predictive response database 400 for use in a contact-based predictive response program. The predictive response database 400 may be associated with a particular contact through a contact identifier. The contact identifier may be a telephone number, email address, user name, user-defined nickname (e.g., “Mom”), or other type of unique identifier. The predictive response database 400 may be associated with more than one contact identifier, for example different identifiers used by the same contact. In such cases, one identifier may be selected as a master identifier, or a new master identifier may be created for the predictive response database 400 (e.g., the name of the contact). The predictive response database 400 includes one or more user elements 402, which are user elements that have previously been used by the user in past communications with the contact and may be suggested to the user in future communications with the contact. The user elements may include words, phrases, or emoticons, actions, and may include elements in different languages (e.g., “Accha”). User elements that are actions may include, for example, attachments of a particular file (e.g., photos, audio, video, PDFs, word processing documents) that a user may frequently send to a contact in response to certain elements of communication.

Each user element 402 is associated with context metadata 404 which describes the context in which the user element was used in previous communications with the contact. The context metadata 404 may include a count indicating the number times the user has previously used the user element in communication with the contact or alternatively, specifically in association with specific contact elements associated with the user element. The context metadata 404 may also include one or more communication elements correlated with the user elements 402. The communication elements may include contact elements and prior user elements that are correlated with the user elements 402. The elements may be determined from the previous N elements that the contact and/or user used in communication before the user used the user element. For example, the context metadata 404 indicates that the element “kids” occurred 50% of the time within the previous N elements sent by the contact or the user before the user used the word “school.” Thus, the context metadata 404 tracks the most frequently used communication elements by the contact or the user prior to the user using the user element, which is a measure of the topical context of the user element with respect to the contact. In some cases, null may be listed as a communication element, which means that in many cases no s communication preceded the user element. For example, the user element “hello” is correlated with a null value 40% of the time, meaning it may usually be used to start a communication.

The context metadata 404 may also store statistics regarding the location of the user when the user element was used. For example, the predictive response database 400 indicates that the user uses the word “birthday” 80% of the time while at home. The context metadata 404 may also store statistics regarding the time at which the user element was used. For example, the predictive response database 400 indicates that the user uses the emoticon “ [symbol] ” between 7 pm and 12 am 50% of the time. The context metadata 404 may also store statistics regarding the medium of communication used by the user to transmit the user element. For example, the predictive response database 400 indicates that the user uses the word “hello” during a voice call 50% of the time and through email 40% of the time. A communication device may contain a voice to text translator that converts voice call data to text data so that call information may be incorporated into the predictive response database 400. Additional context information not illustrated in FIG. 4 may be incorporated into the predictive response database 400, such as statistics regarding the language the user uses to communicate with the contact. The language of communication may be determined from the written script used by the user, for example by determining any specific language keyboards or characters that the user uses when entering in the user element 402. However, in some cases the language the user is using may be inherent in the user element itself or cannot be determined, in which case the language context metadata may be left empty.

The communication device may periodically optimize the storage of the predictive response database 400. For example, the communication device may remove context metadata from communications past a certain time period, or remove statistically insignificant information (e.g., communication elements that are correlated with user elements less than a threshold percentage of the time).

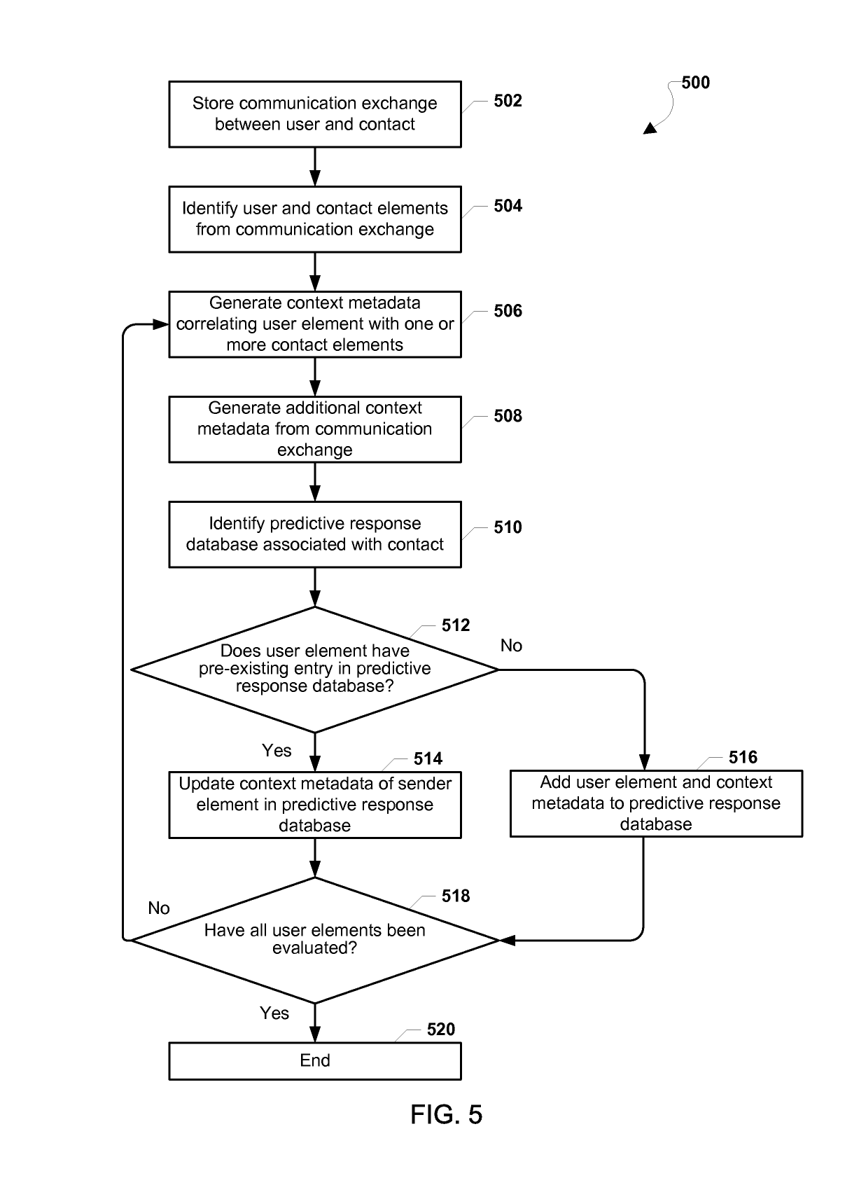

The predictive response database 400 may be created and updated by method 500 illustrated in FIG. 5 according to various embodiments. The method 500 may be implemented with a processor (e.g., the processor 202, a separate controller, and/or the like) of a communication device (such as the communication devices 110, 120, 200, 300) belonging to a user of the communication device. The communication device may include a recording module (such as the recording module 302), a filter module (such as the filter module 304), and one or more predictive response databases stored in memory on the communication device (such as the predictive response databases 306a, 306b) that together with the processor implement a contact-based predictive response program. One or more operations of the method 500 may also be implemented in a remote server in communication with the communication device.

In block 502, the processor may receive and/or store a communication exchange between a user and a contact. The communication exchange may include communication from the user to the contact and communication from the contact to the user. The communication exchange may be obtained from a number of different sources, such as a text message communication, instant messaging communication, email communication, social media communication, voice call communication translated to text and/or other sources providing for communication between a contact and user. In block 504, the processor may identify one or more user elements and contact elements from the communication exchange. A user or contact element may include any element of communication, such as a word, phrase, emoticon, noted action (e.g., noting that the contact attached a file), or null value. The processor may ignore or filter out commonly used words such as “the” and “a” from the user and contact elements.

In block 506, the processor may generate context metadata by correlating a user element with one or more communication elements, which may include user and/or contact elements. The correlation may be based on the N number of contact and/or user elements that preceded a user element in the communication exchange. For example, the processor may correlate a word the user used with the previous three words or other elements that the contact sent to the user. In addition, the processor may correlate a word the user used with the previous three or more words or other elements (e.g., emoticons, images, links, etc.) that the user inputted prior to the current element. The correlated communication elements are stored as context metadata associated with the user element.

In block 508, the processor may generate additional context metadata from the communication exchange. For example, the context metadata may include, among other things, the date or time of the communication exchange, the location of the user during the communication exchange, the language of the communication exchange, and the medium of the communication exchange.

In block 510, the process may identify a predictive response database associated with the contact. The communication device stores one or more predictive response databases associated with various contacts. A predictive response database stores a number of user elements and context metadata associated with each user element, for example as described with reference to FIG. 4. The predictive response databases may be indexed by contact identifiers, such as email addresses, phone numbers, user names, or user-defined names. The processor may obtain a contact identifier from the communication exchange and match the identifier to a predictive response database. If no predictive response database is associated with the contact, the processor may create a new predictive response database and associate the newly created database with the contact identifier.

In determination block 512, the processor may determine whether the user element has a pre-existing entry in the predictive response database. In response to determining that the user element has a pre-existing entry in the predictive response database (i.e., determination block 512=“Yes”), the processor may update the context metadata of the user element in the predictive response database with the context metadata obtained from the communication exchange in block 514. Updating may include incrementing a usage count for the user element, adding the correlated communication elements to previously correlated communication elements, update usage counts or other statistics regarding the frequency of appearance of the communication elements, and updating statistics regarding time, location, language, or medium in which the user element has been used.

In response to determining that the user element does not have a pre-existing entry in the predictive response database (i.e., determination block 512=“Yes”), the processor may add the user element and the context metadata obtained from the communication exchange to the predictive response database in block 516.

After either updating or adding the user element to the predictive response database, the processor may determine whether all user elements identified in the communication exchange have been evaluated in determination block 518. In response to determining that not all user elements in the communication exchange have been evaluated (i.e., determination block 518=“No”), the processor may select another user element and generate context metadata for that user element in block 506. In other words, for each identified user element in the communication exchange, the processor may generate context metadata and store it in the predictive response database associated with the contact.

In response to determining that all user elements in the communication exchange have been evaluated (i.e., determination block 518=“Yes”), the processor may complete the method 500 in block 520 until the processor receives another communication exchange to incorporate into the predictive response database. In this manner, the method 500 provides a way to create and update a contact-based predictive response database.

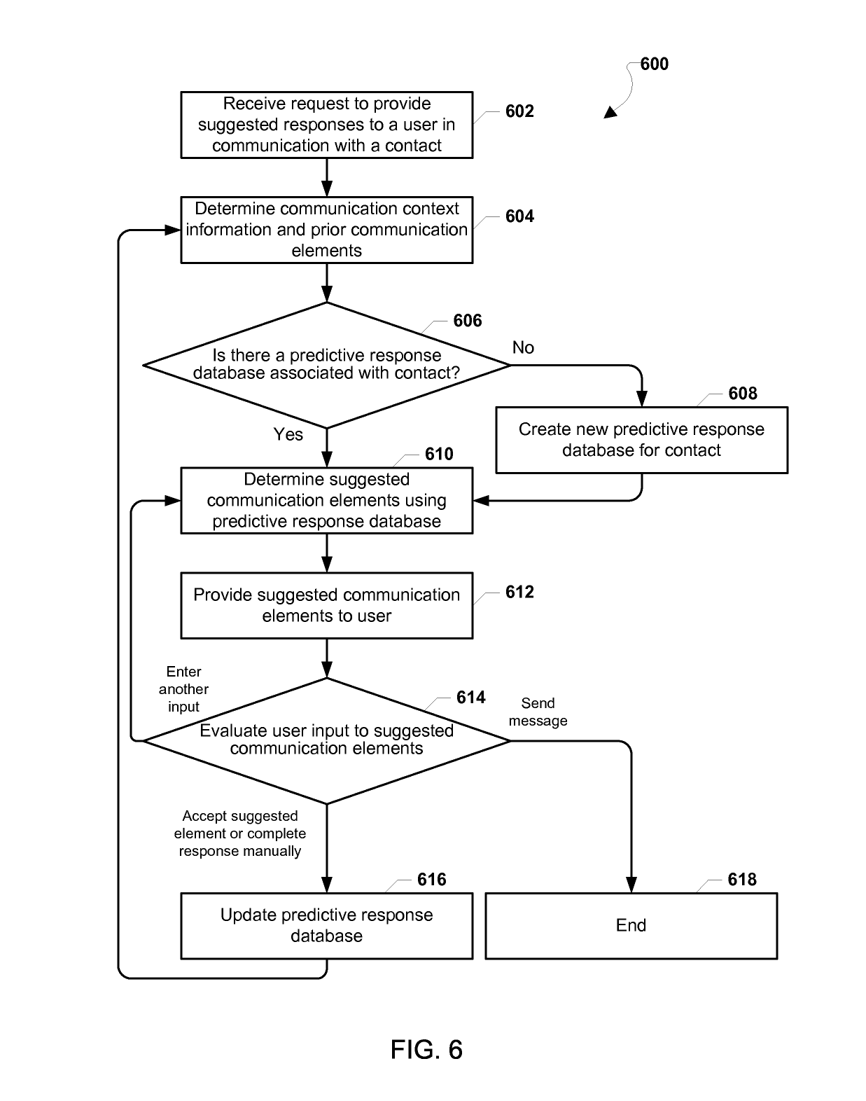

FIG. 6 illustrates a method 600 for using a contact-based predictive response database according to various embodiments. The method 600 may be implemented with a processor (e.g., the processor 202, a separate controller, and/or the like) of a communication device (such as the communication devices 110, 120, 200, 300) belonging to a user of the communication device. The communication device may include a recording module (such as the recording module 302), a filter module (such as the filter module 304), and one or more predictive response databases stored in memory on the communication device (such as the predictive response databases 306a, 306b) that together with the processor implement a contact-based predictive response program. One or more steps of the method 600 may also be implemented in a remote server in communication with the communication device.

In block 602, the processor may receive a request to provide one or more suggested communication elements to a user in a communication exchange with a contact. The communication exchange may occur over various mediums, such as through text messages, instant messaging applications, emails, and social media interactions. The request may originate from the operating system of the communication device or an application that the user is using for the communication exchange. The request may include a contact identifier associated with the contact. The contact identifier may be an email address, phone number, user name, user-defined name, or other contact information that uniquely identifies the contact.

In block 604, the processor may determine communication context information from the communication exchange between the user and the contact, and analyze communications from the recipient to identify prior communication elements. The communication context information may include a communication input already entered by the user. For example, the communication input may be text, an emoticon, a noted action (such as attaching a certain graphic, image and/or audio file), or a null value when the user has not entered any input yet. The communication context information may also include other information about the communication exchange, such as the date or time of the communication exchange, the location of the user during the communication exchange, the language of the communication exchange, and the medium of the communication exchange. The processor may analyze communications received from the contact or previously sent by the user in the communication exchange to identify the prior communication elements, for example by identifying the last N number of elements entered by the contact and/or the user. In some cases, the request may not contain a prefix (e.g., if the user has not typed anything), or may not contain any prior communication elements (e.g., if the communication exchange has just begun).

In determination block 606, the processor may determine whether there is a predictive response database associated with the contact. A predictive response database stores user elements that may be suggested to the user and associated context metadata for each user element. The communication device stores one or more predictive response databases associated with various contacts. The predictive response databases may be indexed by contact identifiers. The processor may try to match a contact identifier of the contact, which may be included in the request, to a predictive response database associated with the same contact identifier. If a contact is associated with a linked group of predictive response databases, the processor may store a list or table that associates the contact identifier with each of the grouped predictive response databases, or with a master identifier for the grouped predictive response databases.

In response to determining that there is no predictive response database that is associated with the contact (i.e., determination block 606=“No”), the processor may create a new predictive response database associated with the contact in block 608. The processor may supplement use of a recently created predictive response database by referencing other predictive response databases that may be grouped with the recently created predictive response database, or with a general global predictive response database stored on the communication device. Alternatively, the processor may also correlate the communication elements in the communication exchange and determine whether the correlation between the communication elements and the communication context information are similar to context metadata of elements stored in any predictive response database stored on the communication device. If there is a similarity, the processor may utilize that predictive response database even though it is not associated with the contact.

In response to determining that there is a predictive response database that is associated with the contact (i.e., determination block 606=“Yes”), or after creating a new predictive response database in block 608, the processor may select the predictive response database and determine one or more suggested communication elements using the predictive response database in block 610. If the contact is associated with a group of predictive response databases, the processor may utilize any number and any combination of the grouped predictive response databases to determine the suggested communication elements. The processor may generate a ranking of the user elements in the predictive response database based on the degree of similarity between the communication context information and user/contact prior communication elements in the communication exchange and the context metadata of each user element. If the communication context information includes a prefix, the processor may narrow down the suggested communication elements using the prefix. For example, if the prefix is “be” then the processor may only consider user elements in the predictive response database that start with “be.” The ranking of user elements may also be based on the similarity between the communication elements and the correlated elements in the predictive response database. For example, if the prior communication elements include the words “apple” and “orange,” the processor may increase the ranking of user elements that have either “apple” or “orange” listed as correlated communication elements in the context metadata. If the communication context information contains additional information such as the time, location, language, or medium of communication, the processor may also utilize the information to determine the ranking of each user element (e.g., user elements used around the same time, or in the same location, or over the same medium, or in the same language).

If the communication context information does not contain any prefix, meaning that the user has not started typing in any response, the processor may still use the prior communication elements to determine one or more suggested communication elements from the predictive response database. If there are no prior communication elements (i.e., a null value), meaning that the communication has just begun, the processor may still use a prefix (if entered by the user) to find one or more suggested communication elements from the predictive response database. The processor may also search for user elements that have correlated elements having a null value in the context metadata, representing user elements that are frequently used to start communications. A timer may be utilized to determine whether the user is initiating a new communication exchange. For example, a chat session between the user and contact may be open but no communication has happened for hours. If the user then starts typing, the processor may determine that the user is initiating a new communication exchange with the contact rather than continuing the previous exchange. In this case, the processor would not include prior communication elements in the previous exchange in determining the suggested communication elements.

In block 612, the processor may provide the one or more suggested communication elements to the user. For example, the processor may cause a display screen on the communication device to display the suggested communication elements as selectable options for the user. The suggested communication elements may include words, phrases, emoticons, or actions. In the case of an action, the device processor may suggest the attachment of a particular file to the user, and if the user accepts the suggestion the device processor may automatically attach or insert the file in the communication application window. The user does not have to manually find and attach the file, which may save time.

In determination block 614, the processor may evaluate the user input to the provided suggested communication elements. In response to determining that the user has entered another input, such as a letter (i.e., determination block 614=“Enter another input”), the processor may re-determine one or more suggested communication elements to the user in block 610. In other words, in response to the user not selecting any suggested communication element but giving another input, the processor may refine or attempt to improve the suggested communication elements provided to the user, using any new prefix information that the user provides via the user's input.

In response to determining that the user has accepted a suggested communication element or has manually completed a response (i.e., determination block 614=“Accept suggested element or complete response manually”), the processor may update the predictive response database based on the selection of a suggested communication element in block 616. In other words, the user has now associated a user element with prior communication elements and communication context information, and the processor may add this information to the predictive response database, for example through the method 500. The processor may then provide suggestions for the next user element by determining new prior communication elements and communication context elements in block 604.

In response to determining that the user has completed and sent a message to the contact (i.e., determination block 614=“Send message”), the processor may complete the method 600 in block 618 until the user initiates another communication. In this manner, the method 600 provides a way to utilize contact-based predictive responses (e.g., suggested letters, words, emoticons, graphics, audio file, etc.) in communications with particular contacts.

A contact may use more than one contact identifier to communicate with the user. For example, the contact may communicate with the user using multiple email addresses, phone numbers, social media usernames, or other unique identifiers. Because predictive response databases are indexed by contact identifiers, a communication device may store multiple predictive response databases for the same contact. The communication device may be able to combine or link these related predictive response databases. Also, the user may have similar communication patterns or contexts with different contacts. This information may be leveraged to improve the contact-based predictive response program.

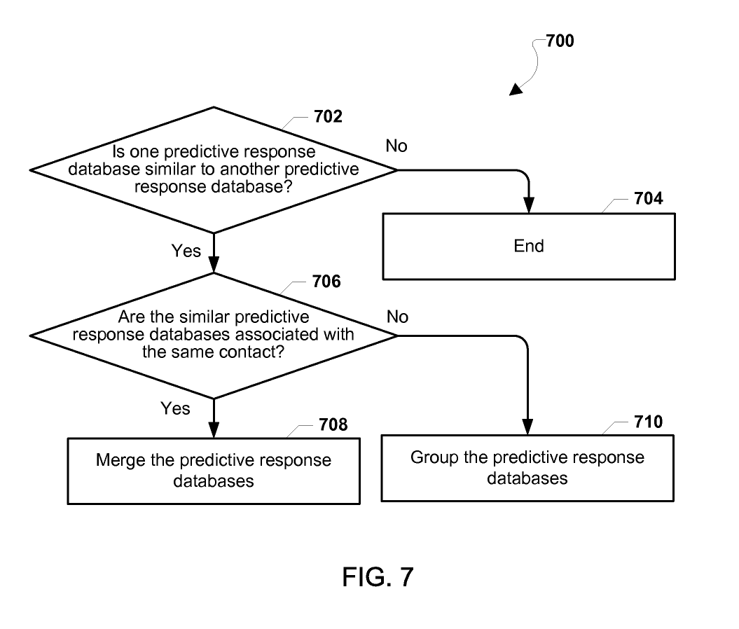

FIG. 7 illustrates a method 700 for comparing, merging, and grouping contact-based predictive response databases according to various embodiments. The method 700 may be implemented with a processor (e.g., the processor 202, a separate controller, and/or the like) of a communication device (such as the communication devices 110, 120, 200, 300) belonging to a user of the communication device. The communication device may include a recording module (such as the recording module 302), a filter module (such as the filter module 304), and one or more predictive response databases stored in memory on the communication device (such as the predictive response databases 306a, 306b) that together with the processor implement a contact-based predictive response program. One or more operations of the method 700 may also be implemented in a remote server in communication with the communication device.

In determination block 702, the processor may determine whether a first predictive response database is similar to a second predictive response database. The processor may compare the user elements in each predictive response database, and for each user element that is in both predictive response databases the processor may compare the context metadata to determine if there are similarities. For example, the user element “travel” may be found in both predictive response databases and the processor may determine whether the user is using the user element “travel” in response to similar contact elements or prior user elements, or in similar time frames or locations, languages, or mediums of communication. The processor may also compare global context metadata, for example the most frequently used language over all user elements or the most frequently used medium of communication over all user elements. Two predictive response databases may be similar if, for example, if there is a similarity between a certain percentage of user elements, or if one or more global context metadata are similar.

In response to determining that the two predictive response databases are not similar (i.e., determination block 702=“No”), the processor may end the method 700 in block 704. In response to determining that the two predictive response databases are similar (i.e., determination block 702=“Yes”), the processor may determine whether the similar predictive response databases are associated with the same contact in determination block 706. For example, the processor may cause a display screen of the communication device to display a request to the user to confirm whether the contact identifiers of the two predictive response databases correspond to the same contact.

In response to determining that the two predictive response databases are associated with the same contact (i.e., determination block 706=“Yes”), the processor may merge the predictive response databases in block 708. In other words, when it is determined that the communication device stores more than one predictive response database corresponding to the same contact, the processor may combine the two predictive response databases into one. The processor may associate both contact identifiers of the two predictive response databases with the new merged predictive response database, or designate one contact identifier as the master identifier for the merged predictive response database, or generate a new master identifier for the merged predictive response database (e.g., the name of the contact).

In response to determining that the two predictive response databases are not associated with the same contact (i.e., determination block 706=“No”), the processor may group the predictive response databases together in block 710. For example, the processor may establish a link so that when the processor utilizes one predictive response database to provide suggested communication elements to a user, the processor also checks the linked predictive response database for additional suggested communication elements. This is done because although the predictive response databases are not associated with the same contact, the communication patterns the user has with each grouped contact is similar. The processor may generate a master identifier for the linked predictive response databases, or the identifiers of both predictive response databases may be associated with both predictive response databases. Thus, multiple predictive response databases may be leveraged to improve the predictive response program. The method 700 may be extendable to compare, merge, or group any number of predictive response databases. In this manner, method 700 provides a way to refine and optimize the storage and use of contact-based predictive response databases on a communication device.

A communication device implementing the various embodiments may use merged or grouped predictive response databases in a manner very similar to the method 600 described above with reference to FIG. 6. For example, when the user engages in a communication with a contact (e.g., upon receiving a message from or drafting a message to the contact), the communication device processor may determine whether there are one or more predictive response databases (e.g., a single database or one or more merged databases) associated with the contact in in determination block 606 by determining whether the contact is associated with either a contact-specific database (e.g., a single contact database or several merged databases) or a grouped database (e.g., a collection of distinct databases that are associated or correlated with each other), and proceed with the method 600 using one or both types of predictive response database associated with the contact. If there is no contact-specific or grouped predictive response database associated with the contact, the communication device processor may analyze the user's communication elements and responses to the contact's communication elements to determine whether any communication patterns are similar to any grouped predictive response databases. If the communication device processor determines that communication elements and responses are similar to a particular grouped predictive response database, the processor may begin using that grouped predictive response database during the rest of the communication session, such as by beginning to use that database in blocks 610 through 614 as described above.

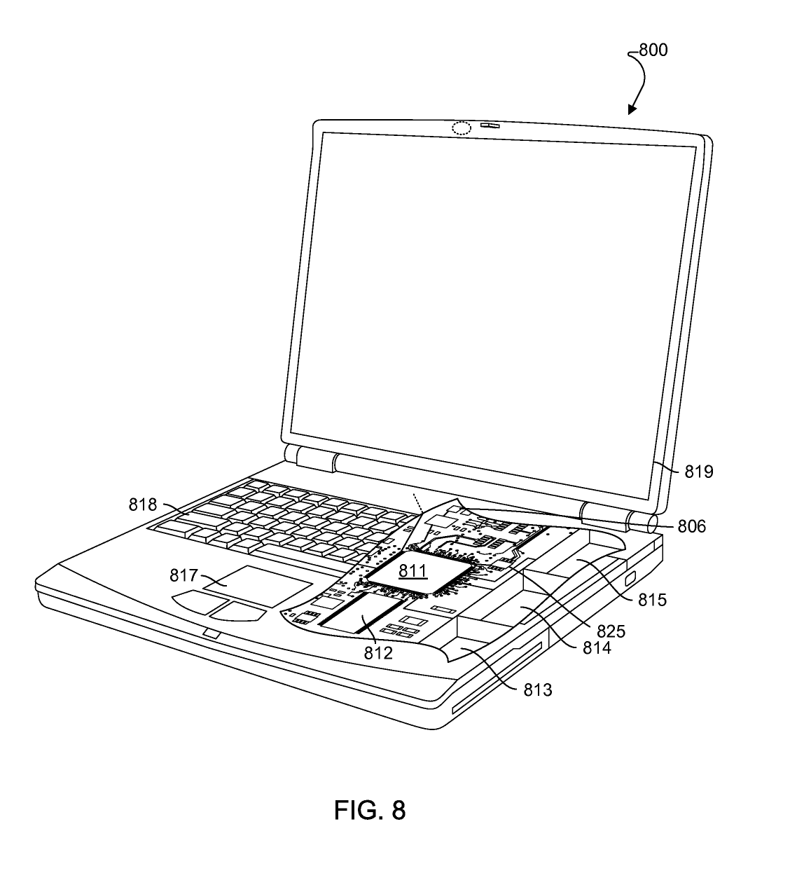

Various embodiments (including, but not limited to, the embodiments discussed above with reference to FIGS. 1-3C), may also be implemented within a variety of communication devices, an example of which is illustrated in FIG. 8. As such, the communication device 800 may implement the methods 500, 600, and 700 according to the various embodiments.

For example, with reference to FIGS. 1-8, a communication device 800 (which may correspond, for example, to the communication devices 120, 200, 300 in FIGS. 1-3C) may include a touchpad touch surface 817 that serves as the pointing device of the communication device 800, and thus may receive drag, scroll, and flick gestures similar to those implemented on wireless devices equipped with a touch screen display and described below. The communication device 800 will typically include a processor 811 coupled to volatile memory 812 and a large capacity nonvolatile memory, such as a disk drive 813 of Flash memory. The communication device 800 may also include a floppy disc drive 814 and a compact disc (CD) drive 815 coupled to the processor 811. The communication device 800 may also include a number of connector ports coupled to the processor 811 for establishing data connections or receiving external memory devices, such as a universal serial bus (USB) or FireWire® connector sockets, or other network connection circuits for coupling the processor 811 to a network. In a notebook configuration, the device housing includes the touchpad 817, the keyboard 818, and the display 819 all coupled to the processor 811. Other configurations of the communication device 800 may include a computer mouse or trackball coupled to the processor (e.g., via a USB input) as are well known, which may also be used in conjunction with various embodiments.

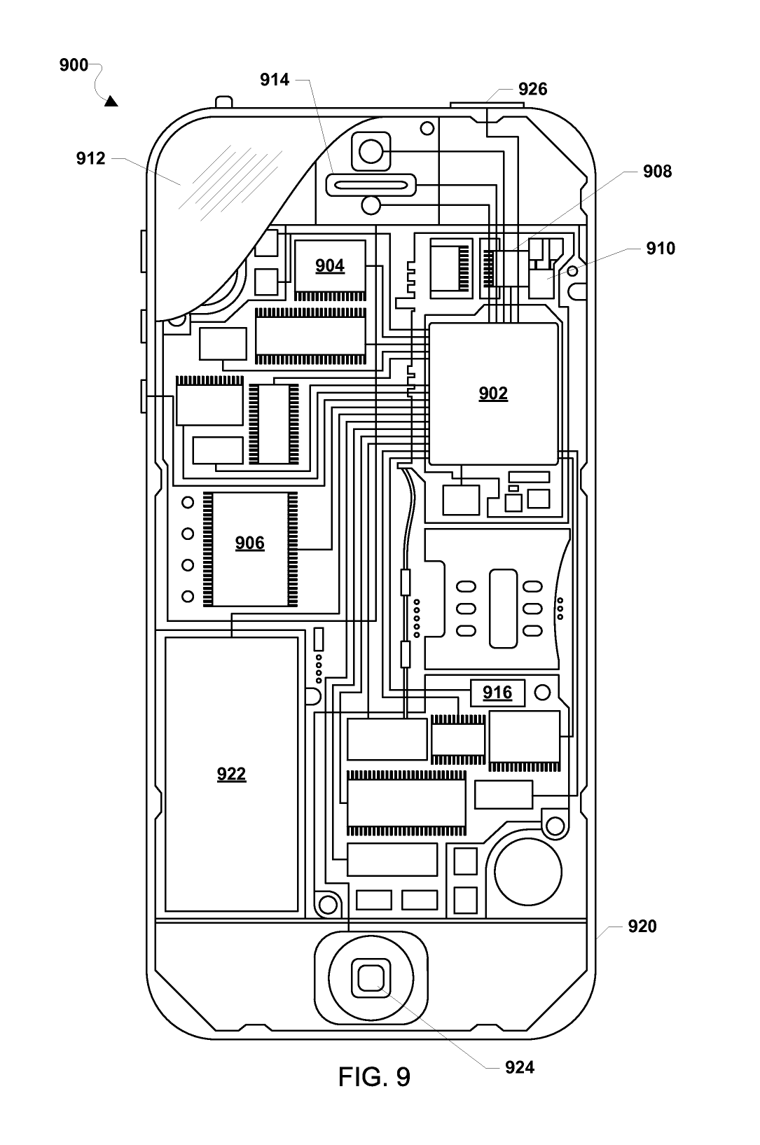

Various embodiments may be implemented in any of a variety of mobile communication devices, an example of which (e.g., mobile communication device 900) is illustrated in FIG. 9. With reference to FIGS. 1-9, the mobile communication device 900 may be similar to the communication devices 110, 120, 150, 200, and 300 as described. As such, the mobile communication device 900 may implement the methods 500, 600, and 700 according to the various embodiments.

The mobile communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile communication device 900 need not have touch screen capability.

The mobile communication device 900 may have one or more cellular network transceivers 908 coupled to the processor 902 and to one or more antennas 910 and configured for sending and receiving cellular communications. The one or more transceivers 908 and the one or more antennas 910 may be used with the above-mentioned circuitry to implement various embodiment methods. The mobile communication device 900 may include one or more SIM cards 916 coupled to the one or more transceivers 908 and/or the processor 902 and may be configured as described above.

The mobile communication device 900 may also include speakers 914 for providing audio outputs. The mobile communication device 900 may also include a housing 920, constructed of a plastic, metal, or a combination of materials, for containing all or some of the components discussed herein. The mobile communication device 900 may include a power source 922 coupled to the processor 902, such as a disposable or rechargeable battery. The rechargeable battery may also be coupled to the peripheral device connection port to receive a charging current from a source external to the mobile communication device 900. The mobile communication device 900 may also include a physical button 924 for receiving user inputs. The mobile communication device 900 may also include a power button 926 for turning the mobile communication device 900 on and off.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the written description. Thus, the present disclosure is not intended to be limited to the embodiments shown herein but is to be accorded the widest scope consistent with the following claims and the principles and novel features disclosed herein.

What is claimed is:

1. A method for using a contact-based predictive response database on a communication device, comprising:
determining communication context information from a communication exchange between a user using the communication device and a contact;
selecting a predictive response database associated with the contact;
determining a suggested communication element from the predictive response database based on a prior communication element identified from the communication exchange and the communication context information; and
providing the suggested communication element to the user.

2. The method of claim 1, wherein the communication context information comprises a communication input already entered by the user.

3. The method of claim 1, wherein the communication context information comprises at least one of an identifier of the contact, a time of the communication exchange, a location of the user during the communication exchange, a language of the communication exchange, and a medium of the communication exchange.

4. The method of claim 1, wherein the prior communication element comprises a word, a phrase, an emoticon, a noted action, or a null value.

5. The method of claim 1, wherein the communication exchange comprises a text translation of a voice call communication.

6. The method of claim 1, wherein selecting a predictive response database associated with the contact comprises selecting the predictive response database associated with an identifier of the contact.

7. The method of claim 1, wherein determining a suggested communication element comprises ranking elements in the predictive response database by comparing the prior communication element and the communication context information with context metadata of each element stored in the predictive response database.

8. The method of claim 1, wherein the suggested communication element comprises a word, a phrase, an action, or an emoticon.

9. The method of claim 1, the method further comprising updating the predictive response database with the suggested communication element by:
correlating the suggested communication element with the prior communication element; and
updating context metadata for the suggested communication element stored in the predictive response database with the communication context information and a correlation between the suggested communication element and the prior communication element.

10. The method of claim 1, further comprising:
determining whether the selected predictive response database is similar to another predictive response database; and
grouping the selected predictive response database and the another predictive response database in response to determining that the selected predictive response database is similar to another predictive response database.

11. The method of claim 1, wherein selecting a predictive response database associated with the contact comprises:
correlating user elements and contact elements in the communication exchange; and
determining whether a correlation between the user elements and the contact elements and the communication context information are similar to context metadata of elements stored in the predictive response database.

12. The method of claim 1, further comprising generating a new contact-based predictive response database associated with the contact, wherein generating the new contact-based predictive response database comprises:
storing the communication exchange, wherein the communication exchange comprises communication from the user;
identifying a user element in the communication from the user;
generating context metadata for the user element, wherein the context metadata comprises a correlation between the user element and the prior communication element identified from the communication exchange and the communication context information; and
storing the context metadata in the new contact-based predictive response database associated with the contact.

13. The method of claim 12, wherein:
the communication exchange is selected from the group consisting of an instant message communication, a text message communication, an email communication, a text translation of a voice call communication, and a social media communication;
the user element comprises a word, a phrase, a noted action, or an emoticon; and
the prior communication element comprises a word, a phrase, an emoticon, or an action.

14. The method of claim 1, wherein the prior communication element comprises a prior contact communication element.

15. A communication device, comprising:
a memory;
a communications module; and
a processor coupled with the memory and the communications module and configured with processor-executable instructions to perform operations comprising:
determining communication context information from a communication exchange between a user using the communication device and a contact;
selecting a predictive response database associated with the contact;
determining a suggested communication element from the predictive response database based on a prior communication element identified from the communication exchange and the communication context information; and
providing the suggested communication element to the user.

16. The communication device of claim 15, wherein the communication context information comprises a communication input already entered by the user.

17. The communication device of claim 15, wherein the communication context information comprises at least one of an identification of the contact, a time of the communication exchange, a location of the user during the communication exchange, a language of the communication exchange, and a medium of the communication exchange.

18. The communication device of claim 15, wherein the prior communication element comprises a word, a phrase, an emoticon, a noted action, or a null value.

19. The communication device of claim 15, wherein the communication exchange comprises a text translation of a voice call communication.

20. The communication device of claim 15, wherein the processor is configured with processor-executable instructions to perform operations such that selecting a predictive response database associated with the contact comprises selecting the predictive response database associated with an identifier of the contact.

21. The communication device of claim 15, wherein the processor is configured with processor-executable instructions to perform operations such that determining a suggested communication element comprises ranking elements in the predictive response database by comparing the prior communication element and the communication context information with context metadata of each element stored in the predictive response database.

22. The communication device of claim 15, wherein the suggested communication element comprises a word, a phrase, an action, or an emoticon.

23. The communication device of claim 15, wherein the processor is configured with processor-executable instructions to perform operations further comprising updating the predictive response database with the suggested communication element by:
correlating the suggested communication element with the prior communication element; and
updating context metadata for the suggested communication element stored in the predictive response database with the communication context information and a correlation between the suggested communication element and the prior communication element.

24. The communication device of claim 15, wherein the processor is configured with processor-executable instructions to perform operations further comprising:
determining whether the selected predictive response database is similar to another predictive response database; and
grouping the selected predictive response database and the another predictive response database in response to determining that the selected predictive response database is similar to another predictive response database.

25. The communication device of claim 15, wherein the processor is configured with processor-executable instructions to perform operations such that selecting a predictive response database associated with the contact comprises:
correlating user elements and contact elements in the communication exchange; and
determining whether a correlation between the user elements and the contact elements and the communication context information are similar to context metadata of elements stored in the predictive response database.

26. The communication device of claim 15, wherein the processor is configured with processor-executable instructions to perform operations further comprising generating a new contact-based predictive response database associated with the contact, wherein generating the new contact-based predictive response database comprises:
storing the communication exchange, wherein the communication exchange comprises communication from the user;
identifying a user element in the communication from the user;
generating context metadata for the user element, wherein the context metadata comprises a correlation between the user element and the prior communication element identified from the communication exchange and the communication context information; and
storing the context metadata in the new contact-based predictive response database associated with the contact.

27. The communication device of claim 26, wherein:
the communication exchange is selected from the group consisting of an instant message communication, a text message communication, an email communication, a text translation of a voice call communication, and a social media communication;
the user element comprises a word, a phrase, a noted action, or an emoticon; and
the prior communication element comprises a word, a phrase, an emoticon, or an action.

28. The communication device of claim 15, wherein the prior communication element comprises a prior contact communication element.

29. A non-transitory processor-readable medium having stored thereon processor-executable instructions configure to cause a processor of a communication device to perform operations comprising:
determining communication context information from a communication exchange between a user using the communication device and a contact;
selecting a predictive response database associated with the contact;
determining a suggested communication element from the predictive response database based on a prior communication element identified from the communication exchange and the communication context information; and
providing the suggested communication element to the user.

30. A communication device, comprising:
means for determining communication context information from a communication exchange between a user using the communication device and a contact;
means for selecting a predictive response database associated with the contact;
means for determining a suggested communication element from the predictive response database based on a prior communication element identified from the communication exchange and the communication context information; and
means for providing the suggested communication element to the user.
